(19) United States
(12) Patent Application Publication
(10) Pub. No.: US 2006/0225060 A1
(43) Pub. Date: Oct. 5, 2006

(54) Code swapping in embedded DSP systems

(76) Inventor: Khalid Goyan, Bromma (SE)

Correspondence Address: COOPER & DUNHAM, LLP, 1185 AVENUE OF THE AMERICAS, NEW YORK, NY, 10036, US

(21) Appl. No.: 11/039,521

(22) Filed: Jan. 19, 2005

(51) Int. Cl. G06F 9/45

(52) U.S. Cl. 717/151; 712/228

(57) ABSTRACT

A method for swapping code in a digital signal processor includes determining whether the code is present in an external memory that is external to the digital signal processor or whether the code is present in an internal memory that is internal to the digital signal processor and copying the code from the external memory to a swap area section of an internal memory when it is determined that the code is present in the external memory.

### BACKGROUND

1. Technical Field

The present invention relates to digital signal processing and, more specifically, to code swapping in embedded digital signal processing systems.

2. Description of the Related Art

Digital Signal Processing (DSP) relates to the examination and manipulation of digital representations of electronic signals. Digital signals that are processed using digital signal processing are often digital representations of real-world audio and/or video.

Digital signal processing often involves examining digital signals in the time domain, spatial domain, frequency domain, autocorrelation domain, and/or wavelet domain. Converting a digital signal between domains generally involves rigorous mathematical computations. Once represented in the desired domain, additional mathematical computations may be performed on the digital signals. For example, various filters may be applied to digital signals. Digital signals may also be subjected to various compression/decompression and encryption/decryption algorithms.

Because digital signal processing often deals with digital representations audio and/or video, digital signal processing must often occur in real-time. Mathematical computations must therefore be performed on the digital signals with little or no observable delay. These mathematical computations may be performed by a general purpose computer system such as a desktop computer or workstation or by specialized digital signal processors (also abbreviated DSP).

Digital signal processors are special-purpose microprocessors that have been optimized for the processing of digital signals. Digital signal processors are generally designed to handle digital signals in real-time, for example, by utilizing a real-time operating system (RTOS). A RTOS is an operating system that may appear to handle multiple tasks simultaneously, for example, as the tasks are received. The RTOS generally prioritizes tasks and allows for the interruption of low-priority tasks by high-priority tasks. The RTOS generally manages memory in a way that minimizes the length of time a unit of memory is locked by one particular task and minimizes the size of the unit of memory that is locked; allowing tasks to be performed asynchronously while minimizing the opportunity for multiple tasks to try to access the same block of memory at the same time.

Digital signal processors are commonly used in embedded systems. An embedded system is a specific-purpose computer that is integrated into a larger device. Embedded systems generally utilize a small-footprint RTOS that has been customized for a particular purpose. Digital signal processing is often implemented using embedded systems comprising a digital signal processor and a RTOS.

Digital signal processors and general purpose computers may utilize direct memory access (DMA) to access available memory, for example using a DMA driver. DMA allows for various elements of the computer system to obtain direct access to available memory, for example, independently of the microprocessor.

Digital signal processors may comprise a microprocessor along with an amount of on-chip memory (also called internal or program memory). Digital signal processors may also utilize external memory that may be accessed by the DSP over an external data bus. External memory, for example, may be nonvolatile memory such as flash memory, EEPROM, etc. Internal memory has many advantages over external memory, for example, internal memory is generally faster and may allow for multiple simultaneous reads and/or writes. For example, internal memory may be comprised of multiple internal memory banks wherein one or more of the multiple memory banks may be accessed simultaneously.

Digital signal processors may be constrained by the amount of available internal memory. Applications that are built for the digital signal processor must generally require less memory than the available program memory (PM). To compensate for this constraint, external memory may be used to store applications when they are not presently in use. Various techniques are used to transfer code from the external memory to the internal memory as needed by the digital signal processor. These techniques are often referred to as code swapping.

Code swapping techniques known in the art generally require additional hardware, for example caches and memory management units, to implement code swapping and/or additional extensions to the digital signal processor's instruction set. Additional hardware and/or extensions to the instruction set may add complexity and/or cost to digital signal processors. It is therefore desirable to perform code swapping in a digital signal processor that does not require additional hardware and/or extensions to the instruction set.

### SUMMARY

A method for swapping code in a digital signal processor includes determining whether the code is present in an external memory that is external to the digital signal processor or whether the code is present in an internal memory that is internal to the digital signal processor and copying the code from the external memory to a swap area section of the internal memory when it is determined that the code is present in the external memory.

A system for swapping code in a digital signal processor includes an external memory that is external to the digital signal processor and an internal memory that is internal to the digital signal processor. The internal memory includes a low latency code section for storing low latency code and a swap area section for storing code that has been copied from the external memory.

A computer system includes a processor and a program storage device readable by the computer system embodying a program of instructions executable by the processor to perform a method for swapping code in a digital signal processor. The method includes determining whether the code is present in an external memory that is external to the digital signal processor or whether the code is present in an internal memory that is internal to the digital signal processor and copying the code from the external memory to a swap area section of the internal memory when it is determined that the code is present in the external memory.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram illustrating a digital signal processor capable of performing code swapping according to an embodiment of the present invention;

FIG. 2 is a chart illustrating a technique used for code swapping according to an embodiment of the present invention;

FIG. 3 is a flow chart showing the “wait on task connect” technique used for code swapping according to this embodiment of the present invention;

FIG. 4 is a flow chart showing the “wait on function call” technique used for code swapping according to an embodiment of the present invention; and

FIG. 5 is a block diagram showing an example of a computer system which may implement the method and system of the present invention.

### DETAILED DESCRIPTION

In describing the preferred embodiments of the present invention illustrated in the drawings, specific terminology is employed for sake of clarity. However, the present invention is not intended to be limited to the specific terminology so selected, and it is to be understood that each specific element includes all technical equivalents which operate in a similar manner.

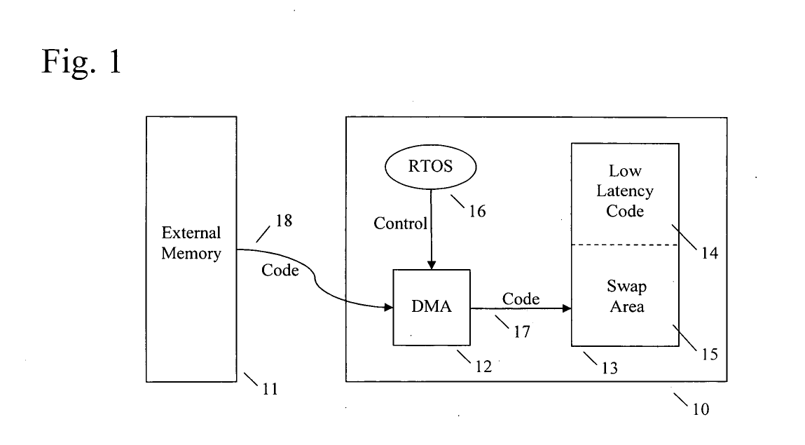

Embodiments of the present invention seek to perform code swapping, for example, in a digital signal processor without requiring additional hardware and/or extensions to the digital signal processor's instruction set. FIG. 1 is a block diagram illustrating a digital signal processor capable of performing code swapping according to an embodiment of the present invention. The digital signal processor 10 may be a general purpose computer programmed to perform digital signal processing or it may be a special-purpose microprocessors that have been optimized for the processing of digital signals. For example, the digital signal processor 10 may be a single microchip or a single integrated electronic circuit (IC).

The present invention may be described with respect to a digital signal processor that is a special-purpose microprocessor however it is to be understood that the present invention may also be applied to a general-purpose computer configured to perform digital signal processing.

The digital signal processor 10 may have internal memory 13. For example, the internal memory 13 may be memory that is built into the digital signal processor microchip or IC. The digital signal processor 10 may be able to communicate with the internal memory 13 over an internal bus 17. The digital signal processor 10 may have a DMA unit 12 that provides access to the internal memory 13, for example, over the internal bus 17. The DMA unit 12 may be comprised of physical circuits or it may be a software component that is executed on the digital signal processor 10.

The digital signal processor 10 may be capable of interpreting an instruction set. The digital signal processor 10 may run an operating system, for example a RTOS 16. For example, the RTOS may be a small-footprint operating system. The RTOS 16 may be compatible with the digital signal processor's 10 instruction set.

The digital signal processor 10 may be connected to external memory 11. The external memory 11 may be located beyond the digital signal processor microchip or IC. The external memory 11 may be connected to the digital signal processor 10 by an external data bus 18. A DMA unit may provide the digital signal processor 10 with access to the external memory. The DMA unit may be the same DMA unit 12 that may be used to provide access to the internal memory 13.

The digital signal processor 10 may have a linker (not shown). A linker may be a program element, for example a process, daemon or service that is capable of assembling various units of code that are required for code execution. A linker may thereby resolve references to undefined symbols by locating the code that defines the unidentified symbols, for example by obtaining the start address of the code and the length of the code and linking that code to the undefined symbols, for example by replacing the unidentified symbols with the code that defines them. A linker may also relocate various units of code within a memory space so that when the code is executed, the various units of code occupy the correct location, relative to one another, to allow the code to execute successfully.

According to embodiments of the present invention, the program memory 13 may be arranged into at least two sections. The program memory 13 may be divided into a low latency code section 14. Memory from the low latency code section 14 may be allocated to code that is critical to the digital signal processor. For example, this code may be code that required low latency and/or high bandwidth. The low latency code section 14 may be of a fixed size or may be variable. For example, the low latency code section 14 may occupy approximately half of the total memory of the internal memory 13.

The program memory 13 may also be divided into a swap area section 15. Memory from the swap area 15 may be allocated to code that is less critical to the digital signal processor. This code may be code that requires less bandwidth than the code that is critical to the digital signal processor. For example, this code may be control codes or on-demand user activated functions. The swap area 15 may be of a fixed size or may be of a variable size. For example, the swap area 15 may occupy approximately half of the total memory of the internal memory 13.

As stated above, the size of the low latency code section 14 and the swap area 15 may be variable. For example, the size of the low latency code section 14 and the size of swap area 15 may be changed to accord with the needs of the digital signal processor 10. For example, a portion of memory that is initially allocated to the swap area 15 may be reallocated to the low latency code section 14 should the digital signal processor 10 require additional low latency code section 14 memory. For example, a portion of the memory that is initially allocated to the low latency code section 14 may be reallocated to the swap area 15 should the digital signal processor 10 require additional swap area 15 memory. However, the combined size of the low latency code section 14 and the swap area 15 may not be able to exceed the total size of the internal memory 13.

The swap area 15 may be controlled by the RTOS 16. Digital signal processors 10 may be able to implement the code swapping of embodiments of the present invention by utilizing the RTOS 16 and/or the linker that has been programmed to implement embodiments of the present invention. For example, a digital signal processor may be converted to implement one or more embodiments of the present invention by updating the RTOS 16 and/or the linker. It may, therefore, not be necessary to modify an instruction set of the digital signal processor 10 in order to implement embodiments of the present invention.

The RTOS 16 may then utilize the DMA 12 to transfer (swap) memory blocks of code from the external memory to the swap area 15 as needed. For example, a digital signal processing application executed on the digital signal processor 10 may initially require that a few blocks of code be swapped into the swap area 15 for execution. When the execution of the application requires one or more blocks of code that are not already present in the swap area 15, the required one or more blocks of code may be transferred into the swap area 15. This may be implemented, for example, by the RTOS 16 implementing a code swap via the DMA 12.

Code that is critical DSP code and is located within the low latency code section 14 may always be available for execution. Therefore no swapping need be required to execute the critical DSP code. The swapping of non-critical code need not prevent the digital signal processor from simultaneously executing other tasks. For example, as non-critical code is being swapped, critical code and/or non-critical code already present in the swap area 15 may be executed to satisfy other tasks.

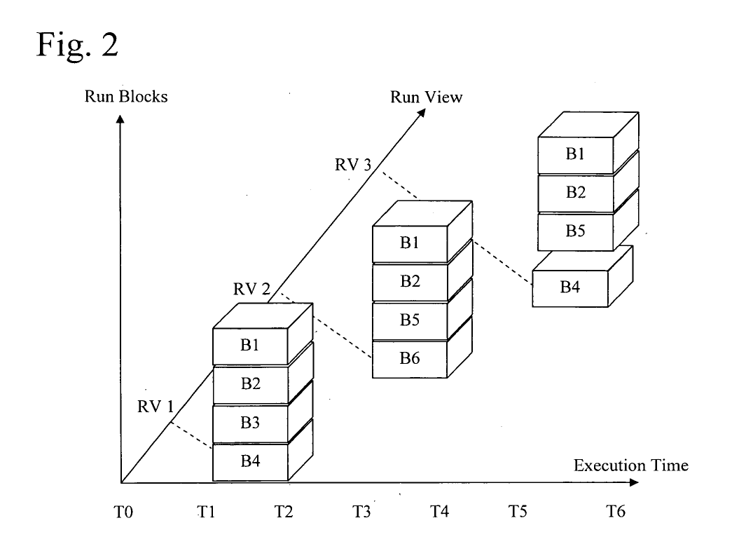

According to one embodiment of the present invention, a “run view” technique may be used to swap code into the swap area 15. FIG. 2 is a chart illustrating a technique used for code swapping according to an embodiment of the present invention.

The run view technique may be implemented, for example, by modifying the linker programming. For example, additional instruction sets may be added to the linker to implement the run view technique. According to an embodiment of the present invention, a run view is a defined arrangement of memory blocks that may reside in program memory for a specific period of time, for example, until an executed application terminates. The memory blocks that comprise a particular run view may be arranged in a particular order and/or memory location, for example, relative to the other memory blocks. The memory blocks that comprise a particular run view may be arranged continuously within the program memory or they may have one or more gaps of memory between them that may be either unused or used by another application. Each run view may comprise the memory blocks desired to execute a particular element of code. For example, a run view may comprise all of the necessary memory blocks to execute a particular application. When the element of code is to be executed, the appropriate run view may be loaded into the swap area of the program memory.

Alternatively, a particular element of code such as an application may require multiple run views in succession. In such a case a first run view (RV1) may be loaded into the swap area of the program memory, for example at time T1. At time T2 when the application requires a different set of memory blocks, the first run view (RV1) may be cleared from the swap area and a second run view (RV2) may be loaded into the swap memory at time T3. Similarly, at time T4 when the application required a different set of memory blocks, the second run view (RV2) may be cleared from the swap area and a third run view (RV3) may be loaded into memory at time T5.

Each run view (RV1, RV2, and RV3) may be comprised of one or more memory blocks containing portions of the particular element of code whose execution is desired. It may be possible for multiple run views to contain one or more of the same memory blocks. For example, the first run view (RV1) and the second run view (RV2) both contain memory block 1 (B1) and memory block 2 (B2). Therefore when the first run view (RV1) is replaced with the second run view (RV2), memory blocks 1 (B1) and 2 (B2) may remain in memory as memory blocks 3 (B3) and 4 (B4) are overwritten and replaced with memory blocks 5 (B5) and 6 (B6).

While the memory blocks (B1-B6) may all reside in external memory, they need not be stored as run views. The various run views may each be assembled in the program memory by the linker as needed, thereby minimizing the need to store the same memory block more than once in external memory. Alternatively each run view may be pre-grouped in the external memory for faster copying into the program memory.

As described above, the linker may be used to assemble the various desired memory blocks from the external memory to the program memory to form the desired run view. The linker, during the linking-time, may accomplish this, for example, by determining what code, definitions and symbols are required for the next phase of a particular code element's execution and inserting this information in a table. This table may then be used by RTOS or other software to accomplish code swapping during the run-time by programming the DMA controller. The table generated by the linker may reside in data memory and include important information for RTOS such as, for example, the size of a block, the start address of the block in external memory, the mapping into local program memory, and other function references inside a block. For example, for each block, the following entry may be created by linker and may reside in data memory:

Block Number: 5

Size: 1024

Start address in external memory: 0xfff3335

Start address in local program memory: 0x123ab

References: get_data, start_counting, decode_my_image

References are symbols associated with a value defined in the executable and linkable format (ELF). A symbol may refer to a function such as “get_data” or a task such as “decode_my_image”.

When a function needs to be called or task to be run, the RTOS may check the reference first and then use this table to perform code swapping if the reference is not in the local program memory.

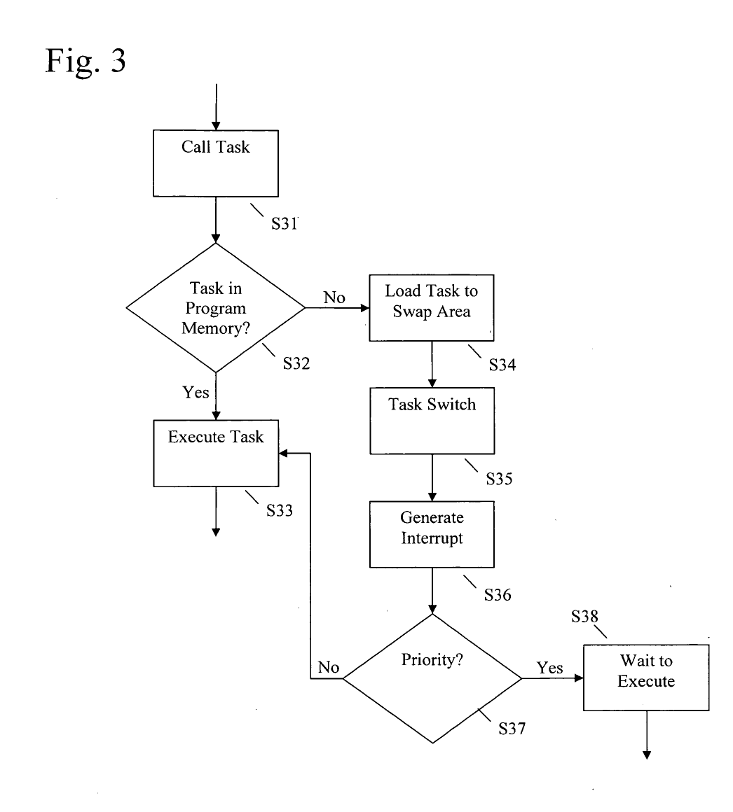

According to one embodiment of the present invention, a “wait on task connect” technique is used to swap code into the swap area. FIG. 3 is a flow chart showing a technique used for code swapping according to this embodiment of the present invention. According to this embodiment, units of executable code, such as units of tasks, may be stored in the external memory. The RTOS may then call upon a task regardless of whether the task is stored in external memory or internal memory (Step S31). This may be carried out, for example, by programming the RTOS to recognize tasks stored in external memory as executable tasks, for example by making it appear as those tasks stored in external memory are actually stored in program memory. It is then determined if the task called is stored in program memory (Step S32). If the task is determined to be stored in program memory (Yes, Step S32) then the task may be executed (Step S33). If the task is not stored in program memory, and is instead stored in external memory (No, Step S32), then the RTOS may program the DMA to load all memory blocks necessary to execute the task to the swap area (Step S34). For example, this step may be implemented by the linker in accordance with the run view technique described above. The RTOS may then perform a task switch (Step S35). A task switch is when the RTOS executes another task, for example a higher priority task, as the required memory blocks are loaded into the swap area. It may be necessary to execute another task that is located in a memory bank of the program memory that is other than the memory bank that the task is being loaded into where the program memory is not capable of multiply accessing a single memory bank. For example, the memory bank of the program memory that the task is loaded into may be selected for being a memory bank of the program memory other than the memory bank of the program memory used by the task that is to be executed while the loading task is loaded into program memory.

After all necessary blocks belonging to the task are successfully loaded into program memory, interrupts may be generated by the DMA controller to indicate for the RTOS that the task is ready for execution (Step S36). A determination may then be made as to whether a task of a higher priority is currently running (Step S37). If it is determined that no task of a higher priority is currently running (No, Step S37), for example no task is currently running or a task of lower priority is currently running, then which ever task that is currently running may be interrupted and the successfully loaded task may be executed (Step S33). If it is determined that a task of a higher priority is currently running then the successfully loaded task may wait to be executed once the task of higher priority is finished executing and no other tasks of higher priority are waiting to be executed (Step S38).

Steps 37 and 38 form an example of priority based scheduling. It is to be understood that embodiments of the present invention may utilize other implementations of priority based scheduling in addition to or in place of steps 37 and 38.

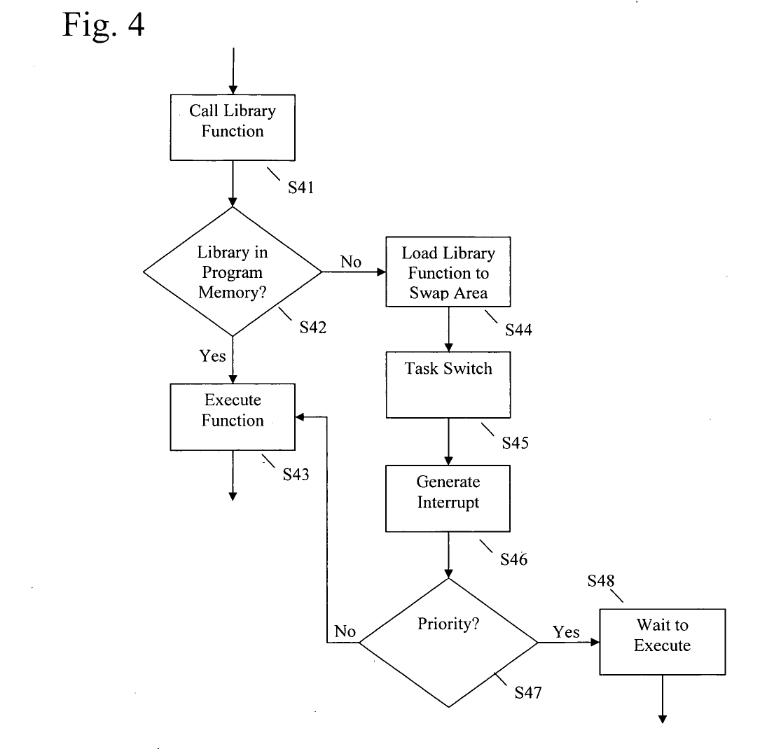

According to another embodiment of the present invention, a “wait on function call” technique may be used to swap code into the swap area. The wait on function call technique is similar to the wait on task connect technique described above. FIG. 4 is a flow chart showing the “wait on function call” technique used for code swapping according to an embodiment of the present invention.

According to this embodiment, libraries of executable functions may be stored in the external memory. The RTOS may then call upon a function regardless of whether the function's library is stored in external memory or internal memory (Step S41). It is then determined whether the library of the function called is stored in program memory (Step S42). If the library of the function called is determined to be stored in program memory (Yes, Step S42) then the function may be executed (Step S43) from the library. If the library of the function called is not stored in program memory and is instead stored in external memory (No, Step S42) then the RTOS may program the DMA to load all memory blocks necessary to execute the function to the swap area (Step S44). For example, either the entire library or the function alone may be loaded into program memory. The RTOS may then perform a task switch (Step S45). In carrying out the task switch, it may be necessary to execute a task that is located in a memory bank of the program memory that is other than the memory bank that the function and/or library is being loaded into where the program memory is not capable of multiply accessing a single memory bank.

After all necessary blocks belonging to the function and/or library are successfully loaded into program memory, interrupts may be generated by the DMA controller to indicate for the RTOS that the function is ready for execution (Step S46). A determination may then be made as to whether a task of a higher priority is currently running (Step S47). If it is determined that no task of a higher priority is currently running (No, Step S47) then which ever task that is currently running may be interrupted and the function may be executed (Step S43). If it is determined that a task of a higher priority is currently running then the function may wait to be executed once the task of higher priority is finished executing and no other tasks of higher priority are waiting to be executed (Step S48).

It is to be similarly understood that embodiments of the present invention may utilize other implementations of priority based scheduling in addition to or in place of steps 47 and 48.

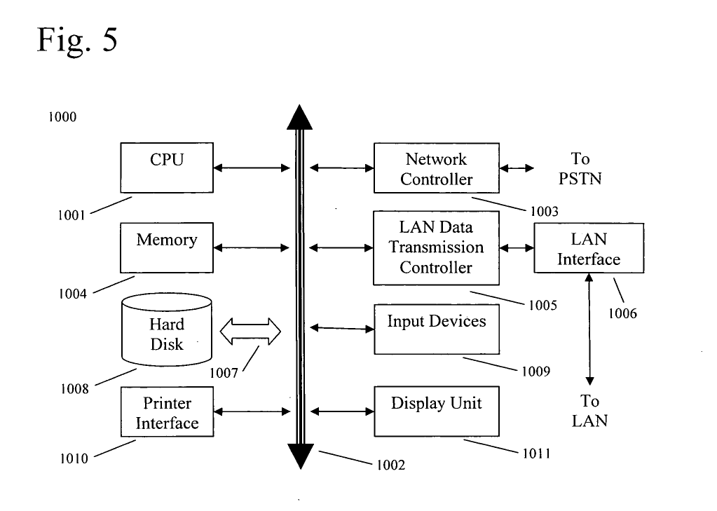

FIG. 5 is a block diagram showing an example of a computer system which may implement the method and system of the present invention. The system and method of the present invention may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the invention or from the scope of the appended claims. For example, elements and/or features of different illustrative embodiments may be combined with each other and/or substituted for each other within the scope of this invention and appended claims.

What is claimed is:

1. A method for swapping code in a digital signal processor, comprising:
determining whether the code is present in an external memory that is external to the digital signal processor or whether the code is present in an internal memory that is internal to the digital signal processor; and
copying the code from the external memory to a swap area section of the internal memory when it is determined that the code is present in the external memory.

2. The method of claim 1, further comprising executing the code from the internal memory when it is determined that the code is present in the internal memory.

3. The method of claim 2, wherein the code is executed from the internal memory according to priority based scheduling.

4. The method of claim 2, further comprising executing the code from the swap area within the internal memory when the code has been copied from the external memory to the swap area within the internal memory.

5. The method of claim 4, wherein the code is executed from the internal memory according to priority based scheduling.

6. The method of claim 1, wherein the code is a memory block of code that is part of a larger application.

7. The method of claim 1, wherein low latency code is present in a low latency code section of the internal memory and code that is not low latency code is present in the external memory.

8. The method of claim 7, wherein the low latency code section of the internal memory comprises a first section of the internal memory and the swap area section of the internal memory comprises a second section of the internal memory.

9. The method of claim 8, wherein the first section of the internal memory occupies approximately half of the internal memory and the second section of the internal memory occupies approximately half of the internal memory.

10. The method of claim 8, wherein the size of the first section of the internal memory and the size of the second section of the internal memory may be changed to accord with the needs of the digital signal processor such that the combined size of the first section of the internal memory and the second section of the internal memory does not exceed the total size of the internal memory.

11. The method of claim 6, wherein a plurality of memory blocks of code comprise a larger application and for each memory block of code:
it is determined whether the memory block of code is present in the external memory or whether the memory block of code is present in the internal memory; and
the code from the external memory is copied to the swap area section of the internal memory when it is determined that the code is present in the external memory, as each of the memory blocks is needed by the digital signal processor.

12. The method of claim 11, wherein one or more of the plurality of memory blocks are initially needed to execute the larger application.

13. The method of claim 12, wherein as the larger application executes, one or more additional memory blocks are needed.

14. The method of claim 12, wherein the one or more of the plurality of memory blocks that are initially needed to execute the larger application comprise a run view.

15. The method of claim 13, wherein the one or more of the plurality of memory blocks that are initially needed to execute the larger application comprise a first run view and the one or more additional memory blocks comprise one or more additional run views.

16. The method of claim 15, wherein multiple run views may have one or more memory blocks in common.

17. The method of claim 15, wherein each of the first run view and additional run views is sequentially copied to the swap area section of the internal memory such that a previous run view is removed from the swap area section of the internal memory prior to a next run view being copied to the swap area section of the internal memory to the extent that the previous run view and the next run view do not share memory blocks in common.

18. The method of claim 11, wherein the larger application is an executable task and each of the plurality of memory blocks of code is a unit of the executable task and the digital signal processor is able to execute the executable task regardless of whether the plurality of units of the executable task are located in the external memory or the internal memory.

19. The method of claim 18, wherein as units of the executable task are being copied to the swap area of the internal memory another executable task may be executed.

20. The method of claim 11, wherein the larger application is a library of executable functions and each of the plurality of memory blocks of code is an executable function and the digital signal processor is able to execute the executable function regardless of whether the library of executable functions is located in the external memory or the internal memory.

21. The method of claim 20, wherein as an executable function is being copied to the swap area of the internal memory another executable function may be executed.

22. A system for swapping code in a digital signal processor, comprising an external memory that is external to the digital signal processor and an internal memory that is internal to the digital signal processor, the internal memory comprising a low latency code section for storing low latency code and a swap area section for storing code that has been copied from the external memory.

23. The system of claim 22, wherein code located on the internal memory is executed by the digital signal processor and code located on the external memory is copied from the external memory to the swap area section of the internal memory and executed by the digital signal processor.

24. The system of claim 23, wherein a linker unit copies the code located on the external memory to the swap area section of the internal memory.

25. The system of claim 23, wherein a DMA unit copies the code located on the external memory to the swap area section of the internal memory.

26. The system of claim 23, wherein a real-time operating system copies the code located on the external memory to the swap area section of the internal memory.

27. The system of claim 23, wherein code is executed from the internal memory according to priority based scheduling.

28. The system of claim 23, wherein the code located on the external memory is a memory block of code that is part of a larger application.

29. The system of claim 23, wherein the code located on the low latency code section of the internal memory is low latency code and the code located on the external memory is not low latency code.

30. The system of claim 23, wherein the low latency code section of the internal memory comprises a first section of the internal memory and the swap area section of the internal memory comprises a second section of the internal memory.

31. The system of claim 30, wherein the first section of the internal memory occupies approximately one-half of the internal memory and the second section of the internal memory occupies approximately one-half of the internal memory.

32. The system of claim 30, wherein the size of the first section of the internal memory and the size of the second section of the internal memory may be changed to accord with the needs of the digital signal processor such that the combined size of the first section of the internal memory and the second section of the internal memory does not exceed the total size of the internal memory.

33. The system of claim 28, wherein a plurality of memory blocks of code comprise a larger application and for each memory block of code:
a real-time operating system determines whether the memory blocks of code are present in the external memory or whether the memory blocks of code are present in the internal memory; and
when the memory block of code is determined to be present on the external memory, the memory block of code is copied to the swap area section of the internal memory, as each of the one or more of the plurality of memory blocks is needed by the digital signal processor.

34. The system of claim 33, wherein one or more of the plurality of memory blocks are initially needed to execute the larger application.

35. The system of claim 33, wherein as the larger application executes, one or more additional memory blocks are needed.

36. The system of claim 34, wherein the one or more of the plurality of memory blocks that are initially needed to execute the larger application comprise a run view.

37. The system of claim 35, wherein the one or more of the plurality of memory blocks that are initially needed to execute the larger application comprise a first run view and the one or more additional memory blocks comprise one or more additional run views.

38. The system of claim 37, wherein multiple run views may have one or more memory blocks in common.

39. The system of claim 37, wherein each of the first run view and additional run views is sequentially copied to the swap area section of the internal memory such that a previous run view is removed from the swap area section of the internal memory prior to a next run view being copied to the swap area section of the internal memory to the extent that the previous run view and the next run view do not share memory blocks in common.

40. The system of claim 33, wherein the larger application is an executable task and each of the plurality of memory blocks of code is a unit of the executable task and the digital signal processor is able to execute the executable task regardless of whether the plurality of units of the executable task are located in the external memory or the internal memory.

41. The system of claim 40, wherein as units of the executable task are being copied to the swap area of the internal memory another executable task may be executed.

42. The system of claim 33, wherein the larger application is a library of executable functions and each of the plurality of memory blocks of code is an executable function and the digital signal processor is able to execute the executable function regardless of whether the library of executable functions is located in the external memory or the internal memory.

43. The system of claim 42, wherein as an executable function is being copied to the swap area of the internal memory another executable function may be executed.

44. A computer system comprising:
a processor; and
a program storage device readable by the computer system, embodying a program of instructions executable by the processor to perform steps for swapping code in a digital signal processor, the steps comprising:
determining whether the code is present in an external memory that is external to the digital signal processor or whether the code is present in an internal memory that is internal to the digital signal processor; and
copying the code from the external memory to a swap area section of the internal memory when it is determined that the code is present in the external memory.
